(19) United States
(12) Patent Application Publication
(10) Pub. No.: US 2009/0107414 A1
(43) Pub. Date: Apr. 30, 2009

(54) Plant for limb and hoof cleaning of livestock

(75) Inventor: Giuliano VECCHIA, Azzanello (Cremona) (IT)

Correspondence Address: YOUNG & THOMPSON, 209 Madison Street, Suite 500, ALEXANDRIA, VA, 22314, US

(73) Assignee: PULI-SISTEM S.R.L., Azzanello (Cremona) (IT)

(21) Appl. No.: 12/258,473

(22) Filed: Oct. 27, 2008

(30) Foreign Application Priority Data
Oct. 25, 2007 (IT) MI2007A002064

(51) Int. Cl. A01K 13/00; A01K 29/00

(52) U.S. Cl. 119/673

(57) ABSTRACT

Plant for the cleaning of the limbs and hooves of livestock, characterised in that it includes a pit for the forced passage of the animals, includes at least a first water container, for the soaking and release of coarse matter, and a second water container equipped with brushing elements, for the removal of the matter adhering to the animal's limb or hoof.

The present invention concerns a plant for the washing of the limbs and hooves of livestock, in particular of cattle, equines and ovine or caprine animals.

The need for prevention and therapy of the digital lesions of reared quadrupeds has been known since ancient times. Evidence exists proving that already in Roman times prophylactic and therapeutic methods were commonly in place to limit and treat limb lesions of equines and cattle.

As a matter of fact, it was possible to detect that limb lesions in reared animals cause economic and management problems to the farmer.

Specifically in the field of cattle rearing, which has a remarkable incidence in the domestic economy of many countries, this type of infection has always represented a very serious problem, particularly felt in intensive cattle farms, where it causes serious economic damage.

As a matter of fact, consequences of such conditions can be:
decrease in milk production;
reduced food intake;
internal competition for food: healthy animals end up choosing better-quality foods;
worsening of reproductive rates;
increase of the incidence of classic postpartum metabolic conditions, such as ketosis and steatosis.
   Recent studies have shown that the incidence of limb conditions in farms of dairy cows ranges between 4.5% and 30%, ranking third in the list of ailments in cattle farms, with respect to the economic damage caused, after infertility and mastitis.

Prophylactic measures, such as functional balancing of the hoof and the practice of foot bathing, are considered positively effective in addressing the problems affecting cattle limbs.

However, it is understood that these practices are particularly burdensome and complicated to be put into practice in intensive farms, due to the understandable problems of space and organisation, given the large numbers of animals to be treated.

The object of the present invention is hence to provide a plant for the automatic and effective cleaning of the limbs and hooves of reared animals, which simultaneously reduces the logistic problems normally correlated with performing such operations in intensive farms.

Said object is achieved by means of a plant having the features described in claim 1).

Further features and advantages of the invention are in any case more evident from the following detailed description of a preferred embodiment, given merely by way of a non-limiting example and illustrated in the accompanying drawings, wherein:

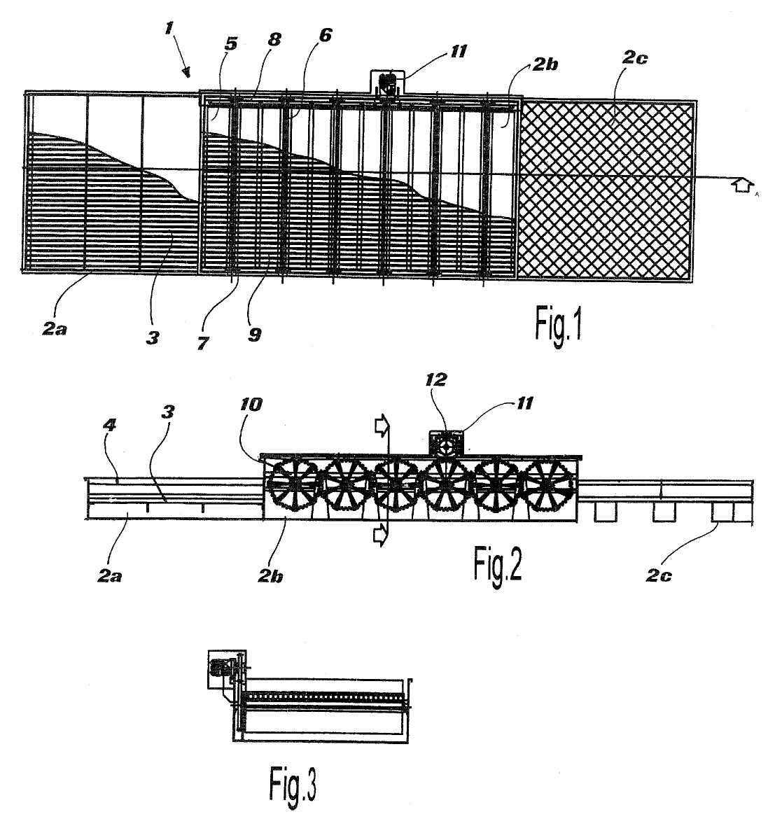

FIG. 1 is a top plan view of a plant for the cleaning according to the invention;

FIG. 2 is a cross-section view along line A-A of the plant of FIG. 1; and

FIG. 3 is a cross-section view, along line B-B shown in FIG. 2, of the plant of FIG. 1.

The plant consists of a pit 1 divided into three basins 2a, 2b and 2c, each basin being designed for a specific function.

Basin 2a is designed for the removal, from the animals' limbs, of coarse debris and the softening of the matter to be removed which has been compressed into the limb gaps. For such purpose, said basin simply consists of a suitably water-filled container, at the walls whereof it is anchored, distanced with respect to the bottom, but below the spillage shoulder, a grid 3, whereon preferably a rubbery, suitably perforated, anti-slip pad 4 is arranged.

Grid 3 has the function of keeping the animal lifted from the bottom of the basin, and consequently of providing a gap for the sedimentation on the bottom of basin 2a of the coarse matter which independently detaches from the animals' feet and falls through grid 3 and pad 4.

Not shown in the drawing, two pipes are provided, for the inflow of fresh water filling the basin and for the (continuous or periodical) outflow of the water wherein the coarse matter has sedimented, respectively. In basin 2a the first removal of such matter is hence provided.

Basin 2b is apt to the removal—by mechanical and energetic action—of the debris which still remain on the limbs and within the hooves. For such purpose, basin 2b consists of a container having a raised containment shoulder with respect to the neighbouring basins, wherein a series of brushes 5 is provided, having a horizontal axis perpendicular to the longitudinal direction of the machine, the shaft 6 whereof is pivoted, freely rotating, on supports 7 arranged in the proximity of the edge of basin 2b. The end of shaft 6 of each brush is provided with a toothed wheel 8 coaxial and integral with shaft 6. Toothed wheels 8 of adjacent brushes are mutually meshed.

A grid 9, for supporting the animals' trampling action, is arranged above shafts 6, so that the bristles 10 of brushes 5 protrude therefrom and thereby come in contact with the animals' limbs and hooves.

Outside of basin 2b, and above the same, there is a motor body 11, which drives a toothed wheel 12 meshed with one of the toothed wheels 8 arranged at the end of shaft 6, so that the actuation of the motor body determines the rotation of brushes 5 according to mutually alternate directions.

In order to promote the arrangement and the anchoring of grid 9, and to reduce the friction due to the presence of water on toothed wheels 8, a smaller-sized container 13 is further provided inside basin 2b, suitably perforated for the passage and free rotation of shafts 6.

Not shown in the drawings, two pipes are provided, for the periodic or continuous inflow and outflow, respectively, of the water filling the basin, following which the bristles 10 of brushes 5 are regularly cleaned when they are immersed into water during rotation.

Finally, basin 3c serves the purpose of disinfecting the animals' limbs and hooves, once they have undergone the treatment of energetic removal of the organic matter and of any foreign bodies wedged-in in the hoof. The structure of the container is evidently simpler, due to the fact that the limbs and hooves are now clean, and it comprises a bottom surface whereon a rubber pad rests.

During operation, the animal is brought into softening basin 2a, where—by walking on rubber, anti-slip pad 3—it is forced to keep its limbs in water. The softening action of water promotes the detachment of coarse organic matter and of foreign material which is easily removable from the limbs, making the brushing operation performed in basin 2b more effective.

Once the animal has walked through basin 2a, it is led to climb into basin 2b, and to advance along the grid of the same, while the bristles 10 of brushes 5 protruding therefrom remove all the material still attached to the limb, or entangled in the hooves. The presence of a large number of counter-rotating brushes allows to perform a complete and fully automated task, without any action being necessary—in normal conditions—by the animal carer.

At the end of the brushing operations the animal is led to walk through the disinfectant bath found in basin 2c for disinfecting any pre-existing abrasion or possibly following the brushing operations, and for guaranteeing that the thus cleaned up limb remains free from the attack of pathogens found in the soil.

It is thereby understood that the set object has been achieved, in particular a plant for the automatic and effective cleaning of farm animals' limbs and hooves has been obtained, accomplishing a structure deputed to these operations in intensive farms.

It is understood that the previous description concerns a preferred embodiment of the invention, which must not be considered limiting of the invention. A person skilled in the field understands that many can be the changes which may be made to what has been reported above, without departing from the invention, which is defined by the attached claims.

1. Plant for the cleaning of the limbs and hooves of reared animals, characterised in that it comprises a pit for the forced walking of the animals comprising at least a first container of water, for the soaking and release of coarse matter and a second container of water provided with brushing means, for the removal of the matter adhering to the limb or to the hoof.

2. Plant as claimed in claim 1), wherein said pit comprises a third container of a disinfectant solution, for the disinfection of pre-existing abrasions and wounds, or abrasions and wounds arising during the brushing operation.

3. Plant as claimed in claim 1), characterised in that said first container provides a grid forming the animals' trampling surface, anchored to the walls of said container, at a distance from the bottom.

4. Plant as claimed in claim 1), characterised in that said brushing means consist of a series of horizontal-axis brushes, perpendicular to the longitudinal direction to the machine, the shaft whereof is pivoted, free to rotate, on supports arranged in the proximity of the edge of said second depression.

5. Plant as claimed in claim 4), characterised in that above the shafts of said brushes a grid panel forming the animals' trampling surface is suspended and anchored, through which the bristles of said brushes protrude.

6. Plant as claimed in claim in 5), characterised in that at the end of the shaft of said brushes there is provided a toothed wheel coaxial and integral therewith, the wheels of adjacent brushes being mutually meshed.

7. Plant as claimed in claim 6), characterised in that the motion of said brushing means is determined by a motor which drives a toothed wheel meshed with one of the toothed wheels of said brushes.

8. Plant as claimed in claim 2), characterised in that a perforated anti-slip pad is provided on the trampling surface of the first and of the third container.

9. Plant as claimed in claim 2), characterised in that said first container provides a grid forming the animals' trampling surface, anchored to the walls of said container, at a distance from the bottom.

10. Plant as claimed in claim 2), characterised in that said brushing means consist of a series of horizontal-axis brushes, perpendicular to the longitudinal direction to the machine, the shaft whereof is pivoted, free to rotate, on supports arranged in the proximity of the edge of said second depression.

11. Plant as claimed in claim 3), characterised in that said brushing means consist of a series of horizontal-axis brushes, perpendicular to the longitudinal direction to the machine, the shaft whereof is pivoted, free to rotate, on supports arranged in the proximity of the edge of said second depression.

12. Plant as claimed in claim 9), characterised in that a perforated anti-slip pad is provided on the trampling surface of the first and of the third container.
